(19) United States
(12) Patent Application Publication
(10) Pub. No.: US 2010/0186595 A1
(43) Pub. Date: Jul. 29, 2010

(54) COMPOSITE FILTER AND GAS FILTER ASSEMBLY INCLUDING THE SAME

(75) Inventor: Yii-Feng Huang, Tainan Hsien (TW)

Correspondence Address: HOLLAND & HART, LLP, P.O BOX 8749, DENVER, CO, 80201, US

(73) Assignee: KANG NA HSIUNG ENTERPRISE CO., LTD., Tainan Hsien (TW)

(21) Appl. No.: 12/358,757

(22) Filed: Jan. 23, 2009

(51) Int. Cl. B01D 39/10

(52) U.S. Cl. 96/226; 55/525; 55/524; 55/495

(57) ABSTRACT

A composite filter includes a mesh screen layer having 30 to 200 mesh, a first non-woven fabric layer disposed on the mesh screen layer, and a second non-woven fabric layer disposed between the mesh screen layer and the first non-woven fabric layer. The first non-woven fabric layer has a higher filtration efficiency than that of the second non-woven fabric layer for particles having a particle size of 0.3 μm. A gas filter assembly includes the aforesaid composite filter pleated in a zigzag fashion, and a frame for holding and surrounding the composite filter.

### BACKGROUND OF THE INVENTION

1. Field of the Invention

This invention relates to a composite filter and a gas filter assembly, more particularly to a composite filter having a mesh screen layer and first and second non-woven fabric layers, and a gas filter assembly including the aforesaid composite filter.

2. Description of the Related Art

A filter used in an air cleaner is usually made from a non-woven fabric composed of multiple web layers each of which has a plurality of pores with irregular pore size. With adjustment of the pore size of the non-woven fabric, when air passes through the non-woven fabric in the air cleaner, the particles, dusts, etc. contained in the air can be removed, thereby resulting in an air cleaning effect. When the pore size of the non-woven fabric is designed to be relatively large, the filtration efficiency becomes poor. However, when the pore size of the non-woven fabric is designed to be relatively small, although the filtration efficiency can be improved, the pores of the non-woven fabric are easily clogged with the particles and dusts. Since the particles and dusts retained on or trapped in the non-woven fabric are difficult to be removed, the filter should be replaced frequently, thereby resulting in an increase in operational costs.

### SUMMARY OF THE INVENTION

Therefore, the object of the present invention is to provide a composite filter and a gas filter assembly that can overcome the aforesaid drawback of the prior art.

According to one aspect of this invention, a composite filter for purifying gas includes a mesh screen layer having 30 to 200 mesh, a first non-woven fabric layer disposed on the mesh screen layer, and a second non-woven fabric layer disposed between the mesh screen layer and the first non-woven fabric layer. The first non-woven fabric layer has a higher filtration efficiency than that of the second non-woven fabric layer for particles having a particle size of 0.3 μm.

According to another aspect of this invention, a gas filter assembly includes the aforesaid composite filter pleated in a zigzag fashion, and a frame for holding and surrounding the composite filter.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is a fragmentary partly sectional view of the preferred embodiment of a composite filter according to this invention;

FIG. 2 is an exploded perspective view of the preferred embodiment of a gas filter assembly according to this invention;

FIG. 3 is an assembled perspective view of the preferred embodiment shown in FIG. 2; and

FIG. 4 is a partly cross-sectional view of the preferred embodiment shown in FIG. 3.

### DETAILED DESCRIPTION OF THE PREFERRED EMBODIMENTS

Basically, a composite filter according to the present invention includes a mesh screen layer having 30 to 200 mesh, a first non-woven fabric layer disposed on the mesh screen layer, and a second non-woven fabric layer disposed between the mesh screen layer and the first non-woven fabric layer. The mesh screen layer, the second non-woven fabric layer, and the first non-woven fabric layer are arranged in the listed order from an upstream side of an air flow. The first non-woven fabric layer has a higher filtration efficiency (>50%) than that of said second non-woven fabric layer (<50%) for particles having a particle size of 0.3 μm. Preferably, the mesh screen layer has a filtration efficiency greater than 50% for particles having a particle size of at least 10 μm. The second non-woven fabric layer has a filtration efficiency greater than 50% for particles having a particle size of at least 1 μm. The first non-woven fabric layer has a filtration efficiency greater than 50% for particles having a particle size of at least 0.3 μm.

The mesh screen layer having a relatively dense mesh size (i.e., 30-200 mesh) can be manufactured by a weaving process or an injection molding process. The material for the mesh screen layer varies with the manufacturing process. For example, polyethylene (PE), polypropylene (PP), polyester (PET), nylon, and polytetrafluorethylene (PTFE) are used in the weaving process. PE, PP, and PET, which are thermoplastic, are used in the injection molding process. Since the mesh screen layer used in this invention has a relatively dense screen structure, it is preferably made using a weaving process.

In an embodiment, the mesh screen layer is a woven fabric made from hydrophobic mono-filaments (e.g., PE mono-filaments). By virtue of the mesh screen layer, after using the composite filter for a period of time, particles that do not pass through the mesh screen layer can accumulate on a surface of the mesh screen layer, thus forming a filter cake which can act as a filter medium. The filtration efficiency of the composite filter can therefore be enhanced. Due to poor adhesion between the filter cake and the mono-filaments of the mesh screen layer, when the filter cake is too thick to provide a good filtration efficiency (i.e., the pressure drop becomes too high), it can be easily removed from the mesh screen layer. After removal of the filter cake, the composite filter can be further used for a period of time, thereby prolonging the lifetime of the composite filter.

The second non-woven fabric layer can be made from, for example, hot-air-through nonwovens, needle punching nonwovens, or resin bond nonwovens. The fiber used in the second non-woven fabric layer can be a single-component fiber or a composite fiber (arranged in the form of side-by-side or core-sheath fashion). Examples of the material suitable for the fiber of the second non-woven fabric layer include, e.g., PP, PE, PET, PE/PP, PE/PET, and PET/PET. Since the material used to manufacture a non-woven fabric is well known, further details of the same are omitted herein for the sake of brevity, and a skilled artisan can choose an appropriate one based on cost and manufacturing considerations.

The first non-woven fabric layer can be made from, for example, melt-blown nonwovens, spunbond-meltblown-spunbond (SMS) nonwovens, spunbond-meltblown-meltblown-spunbond (SMMS) nonwovens, hot-air-through nonwovens, or needle punching nonwovens. The material for the first non-woven fabric layer is substantially the same as that for the second non-woven fabric layer, and thus, further details will not be described herein.

Preferably, at least one of the mesh screen layer, the first non-woven fabric layer, and the second non-woven fabric layer has a functional material. The functional material may be an anti-bacterial agent, an anti-fungal agent, a deodorant, a fire retardant, an anionic material, an infrared material, a CO conversion material, an aldehyde absorbent, or an oxygen enhancer, and may be attached to one or more of the aforesaid layer(s) by spray coating process or immersing process. If two or more different functional materials are to be attached onto the same layer, the functional materials should be selected such that they are not reactive to each other. Alternatively, the composite filter according to this invention can include a functional non-woven fabric layer having at least one of the aforesaid functional materials. Optionally, the functional non-woven fabric layer containing the aforesaid functional material can be disposed between the mesh screen layer and the second non-woven fabric layer, between the second non-woven fabric layer and the first non-woven fabric layer, or on the first non-woven fabric layer opposite to the second non-woven fabric layer based on the functional properties thereof. The pore size of the functional non-woven fabric layer may be varied according to the position where the functional non-woven fabric layer is disposed, but should be chosen such that the pore size does not affect the filtration efficiency of the first and second non-woven fabric layers. Preferably, the pore size of the functional non-woven fabric layer is substantially similar to that of the second non-woven fabric layer.

In general, when a filter is used in a compact air cleaner, in order to increase contact surface area between the filter and air without increasing the size of the filter, the filter is usually pleated or corrugated. For a conventional filter that includes only non-woven fabrics which are soft and difficult to be retained in a properly pleated shape, heating (for the purpose of softening the non-woven fabrics) and cooling (for the purpose of hardening the non-woven fabrics) steps are required for pleating the non-woven fabric layers, thereby complicating the fabrication of the filter. In this invention, since the mesh screen layer has a relatively high stiffness, when the composite filter of this invention is pleated, it can be retained stably in a desired shape (e.g., a zigzag fashion) without heating and cooling steps, thereby simplifying the manufacturing process and reducing costs.

To avoid delamination of the layers of the composite filter, the mesh screen layer, the first and second non-woven fabric layers, and the functional layer (if any) are bound together by applying a hot melt adhesive onto fiber surfaces of the layers or by needle-punching. The aforesaid binding method can eliminate the problem of increasing pressure drop encountered by an ultrasonic binding method.

According to a preferred embodiment, a gas filter assembly is provided by assembling the pleated composite filter into a frame which supports and surrounds the pleated composite filter. The gas filter assembly can be easily and directly installed in an air cleaner.

### EXAMPLES

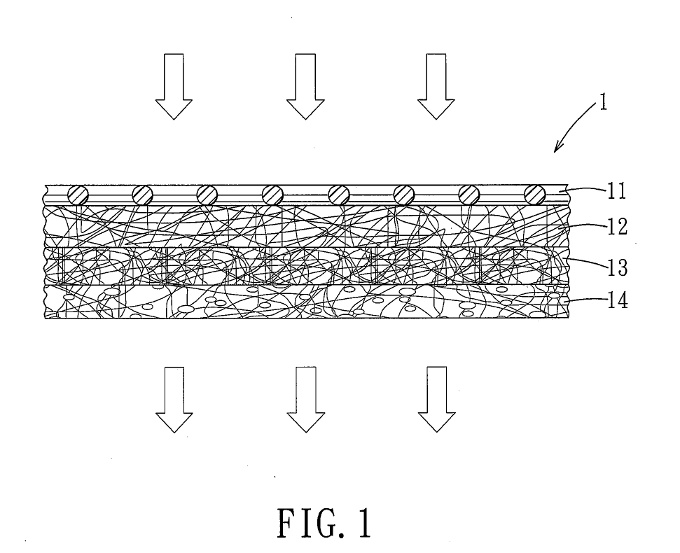

FIG. 1 illustrates an example of the composite filter 1 according to this invention. The composite filter 1 includes a mesh screen layer 11, a second non-woven fabric layer 12, a first non-woven fabric layer 13, and a functional non-woven fabric layer 14. The mesh screen layer 11 is a woven fabric having warp and weft yarns made from polyethylene mono-filaments. The mesh screen layer 11 has a basis weight of 84 to 132 g/m² and a mesh size of 60 mesh suitable for filtering particles with a size of larger than 10 μm. The second non-woven fabric layer 12 in this embodiment is an electrostatic hot-air-through non-woven fabric layer made from polyethylene, has a basis weight of 13 to 33 g/m², and is suitable for filtering particles with a size of 1-10 μm. The first non-woven fabric layer 13 is a melt-blown non-woven fabric layer made from polypropylene, has a basis weight of 18 to 22 g/m², and is suitable for filtering particles with a size of 0.3-1 μm. The functional non-woven fabric layer 14 is a resin bond non-woven fabric layer coated with chitin (an anti-bacterial agent), and has a basis weight of 47 to 68 g/m². According to this invention, other commercial anti-bacterial agents (e.g., nano-silver) can be used to replace chitin. In assembly, the mesh screen layer 11, the second non-woven fabric layer 12, the first non-woven fabric layer 13, and the functional non-woven fabric layer 14 are stacked in the order shown in FIG. 1, and are gas-permeably bound together using a hot melt adhesive.

In use, an air-flow (represented by arrows) enters the mesh screen layer 11 disposed at a location upstream of the air-flow, and then passes through the second non-woven fabric layer 12, the first non-woven fabric layer 13, and the functional non-woven fabric layer 14 in sequence (i.e., multi-layered filtration).

### Experiment 1

Each of the aforesaid layers (40 cm×47 cm) before being stacked together was subjected to a filtration efficiency test for particles having particle sizes of 0.3 μm, 1.0 μm, and 10 μm. A gas flow (60 CFM) having a predetermined amount of the particles with the aforesaid different sizes was produced using an aerosol generator, and was arranged to pass through the aforesaid layers, separately. The number of the particles at upstream and downstream sides of each layer was measured using a particle counter. The filtration efficiencies for the layers are shown in Table 1. The test results indicate that the mesh screen layer has a filtration efficiency greater than 50% for particles having a particle size of at least 10 μm, the second non-woven fabric layer has a filtration efficiency greater than 50% for particles having a particle size of at least 1 μm, and the first non-woven fabric layer has a filtration efficiency greater than 50% for particles having a particle size of at least 0.3 μm.

TABLE 1

| | | Pressure | Number of | Particle size (μm)/ | | |
|---|---|---|---|---|---|---|
| | | drop | Particles on | filtration | | |
| | | (mm | the upstream | efficiency (%) | | |
| | CFM | H₂O) | side | 0.3 | 1.0 | 10.0 |
| Mesh | 60 | 0.1 | 180000-250000 | 2.858 | 4.724 | 50.667 |
| screen | | | 400000-500000 | 3.138 | 5.211 | 53.158 |
| layer | | | | | | |
| Second | 60 | 0.2 | 180000-250000 | 30.440 | 64.743 | 97.222 |
| non- | | | 300000-400000 | 27.427 | 60.307 | 91.228 |
| woven | | | | | | |
| fabric | | | | | | |
| layer | | | | | | |
| First | 60 | 2.3 | 180000-250000 | 89.465 | 98.830 | 99.990 |
| non- | | | | | | |
| woven | | | | | | |
| fabric | | | | | | |
| layer | | | | | | |
| Functional | 60 | 0.3 | 180000-250000 | 3.706 | 6.710 | 57.746 |
| non- | | | 300000-400000 | 3.825 | 6.420 | 58.974 |
| woven | | | | | | |
| fabric | | | | | | |
| layer | | | | | | |

### Experiment 2

The second non-woven fabric layer 12 and the first non-woven fabric layer 13 were bound together using a hot melt adhesive so as to form a two-layer laminated structure (Comparative Example 1). The second non-woven fabric layer 12, the first non-woven fabric layer 13, and the functional non-woven fabric layer 14 were bound together using a hot melt adhesive so as to form a three-layer laminated structure (Comparative Example 2). The mesh screen layer11, the second non-woven fabric layer 12, the first non-woven fabric layer 13, and the functional non-woven fabric layer 14 were bound together using a hot melt adhesive so as to form a four-layer laminated structure (Example 1). The thickness of each of the laminated structures was measured using a thickness gauge (TECLOCK SMD-540). The air permeability for each of the laminated structures was measured using a FX3300 air permeability tester with a 70 mm diameter opening (TEXTEST Instruments, Switzerland) at a pressure of 125 Pa. The pressure drop and filtration efficiency for each of the laminated structures was measured using a TSI 8130 automated filter tester under the following conditions: flow rate: 32 LPM; aerosol particles: NaCl; density of the particle: 20 mg/m³; mass mean diameter of the particle: 0.26 μm; electric charge neutralization system: ON; and time for test: 1 minute. The results are shown in Table 2.

TABLE 2

| | Basis | | Air | Pressure | Filtration |
|---|---|---|---|---|---|
| | weight | Thickness | permeability | drop | efficiency |
| | (g/m²) | (mm) | (cc/cm²/sec) | (mm H₂O) | (%) |
| Ex. 1 | 175-250 | 1.20-2.00 | 42.0-49.4 | 1.3-1.7 | 96.5-93.5 |
| Comp. | 30-60 | 0.59-1.60 | 46.2-56.2 | 1.3-1.7 | 94.3-90.4 |
| Ex. 1 | | | | | |
| Comp. | 75-130 | 0.85-1.42 | 40.1-58.8 | 1.3-2.0 | 96.1-92.7 |
| Ex. 2 | | | | | |

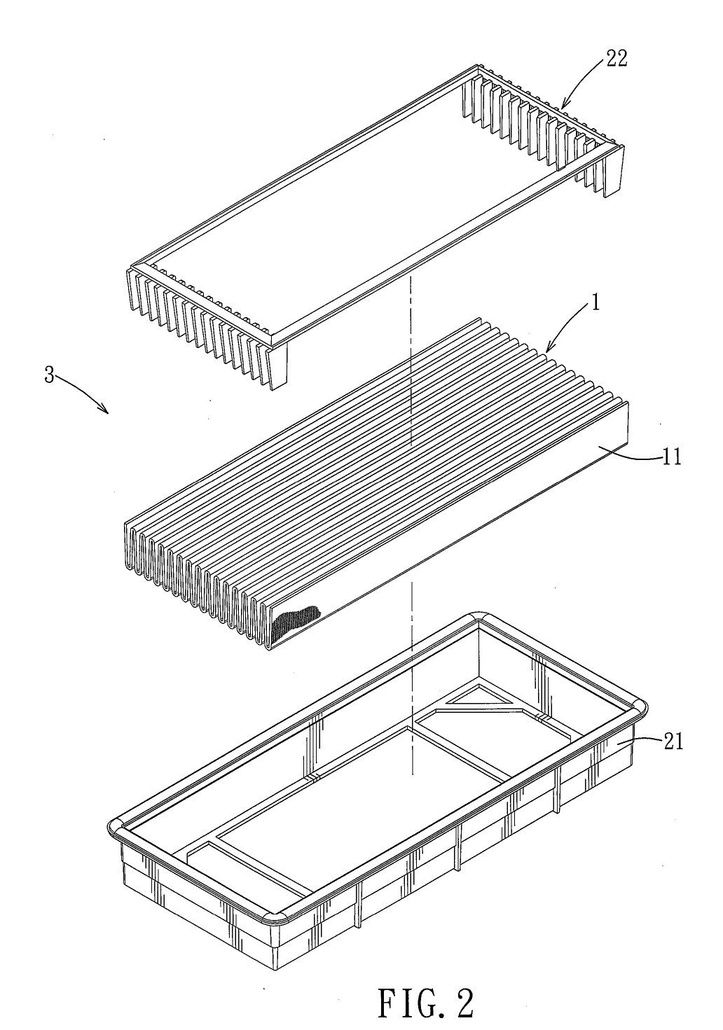

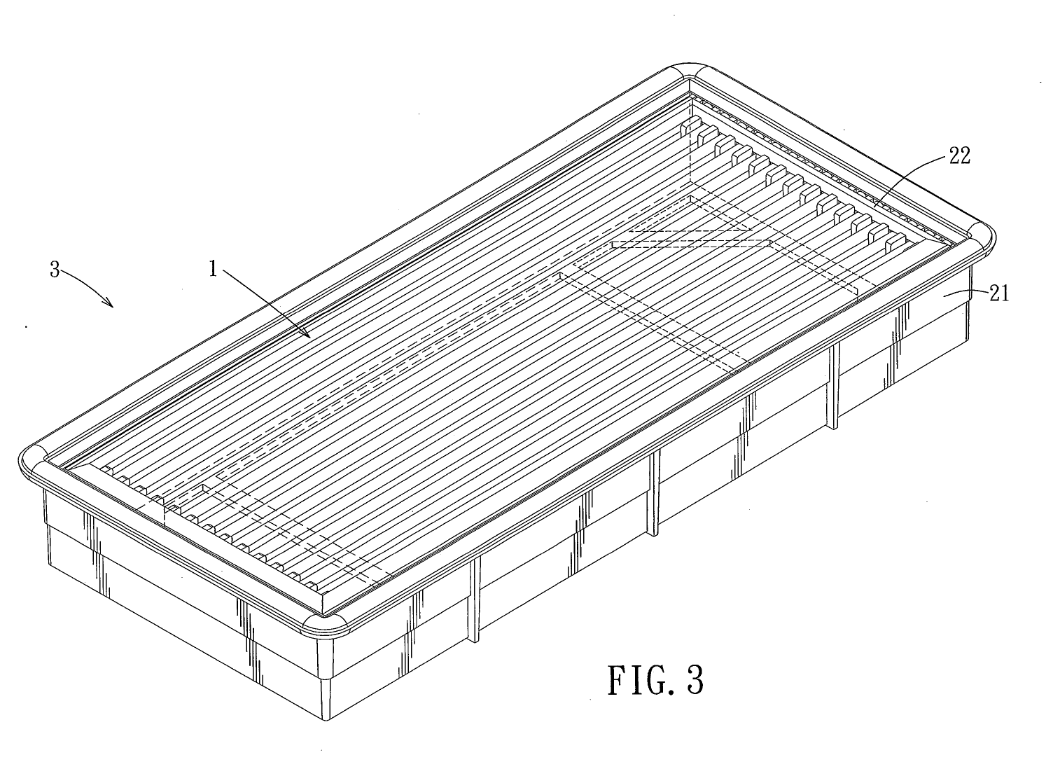

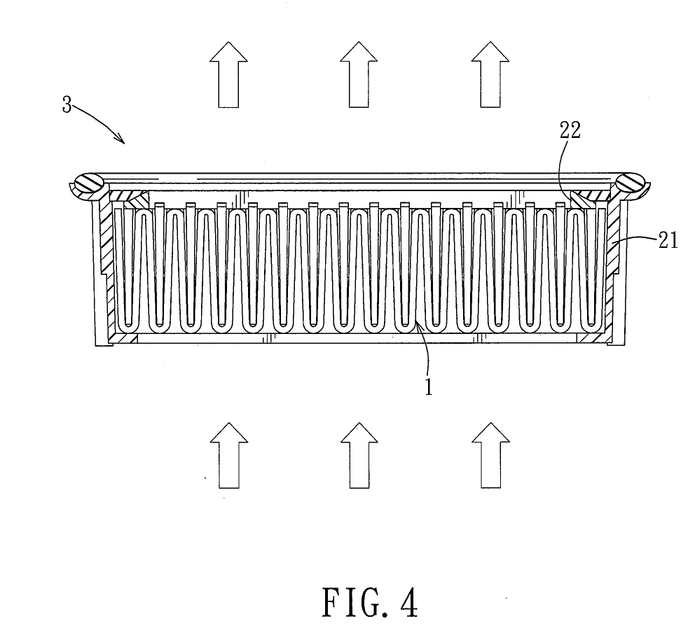

FIGS. 2 and 3 illustrate the preferred embodiment of a gas filter assembly 3 according to this invention, which includes the composite filter 1 pleated in a zigzag fashion, a frame 21 having an accommodating space, and a fixing member 22. The frame 21 and the fixing member 22 are made from ABS material using an injection molding process. The composite filter 1 is firstly supported on the fixing member 22. Thereafter, the composite filter 1 and the fixing member 22 are placed in the accommodating space of the frame 21 which is then glued to the fixing member 22 using an adhesive. In use, as shown in FIG. 4, an air flow passes through the gas filter assembly 3 in a direction shown by arrows.

According to the present invention, with the mesh screen layer having a 30-200 mesh, relatively large particles removed from the gas/air flow can accumulate on a surface of the mesh screen layer as a filter cake. Since the filter cake can act as a filtration medium which can further filter out an additional amount of particles and which can be easily removed from the mesh screen layer, the problem of clogging of the pores in the non-woven fabric layers is alleviated, thereby prolonging the lifetime of the composite filter. In addition, because of the relatively high stiffness of the mesh screen layer, heating and cooling steps are not needed in the process of pleating the composite filter, thereby reducing manufacturing steps and costs.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A composite filter, comprising:
a mesh screen layer having 30 to 200 mesh;
a first non-woven fabric layer disposed on said mesh screen layer; and
a second non-woven fabric layer disposed between said mesh screen layer and said first non-woven fabric layer;
wherein said first non-woven fabric layer has a higher filtration efficiency than that of said second non-woven fabric layer for particles having a particle size of 0.3 μm.

2. The composite filter of claim 1, wherein said mesh screen layer is a woven fabric made from mono-filaments.

3. The composite filter of claim 2, wherein said mono-filaments are hydrophobic.

4. The composite filter of claim 2, wherein said mono-filaments are polyethylene mono-filaments.

5. The composite filter of claim 4, wherein said mesh screen layer has 60 mesh.

6. The composite filter of claim 5, wherein said mesh screen layer has a filtration efficiency greater than 50% for particles having a particle size of at least 10 μm, said second non-woven fabric layer having a filtration efficiency greater than 50% for particles having a particle size of at least 1 μm, said first non-woven fabric layer having a filtration efficiency greater than 50% for particles having a particle size of at least 0.3 μm.

7. The composite filter of claim 1, wherein at least one of said mesh screen layer, said first non-woven fabric layer, and said second non-woven fabric layer has a functional material attached thereto.

8. The composite filter of claim 7, wherein said functional material is selected from the group consisting of an anti-bacterial agent, an anti-fungal agent, a deodorant, a fire retardant, an anionic material, an infrared material, a CO conversion material, an aldehyde absorbent, and an oxygen enhancer.

9. The composite filter of claim 1, further comprising a functional non-woven fabric layer having a functional material and connected to one of said mesh screen layer, said first non-woven fabric layer, and said second non-woven fabric layer

10. The composite filter of claim 9, wherein said functional material is selected from the group consisting of an anti-bacterial agent, an anti-fungal agent, a deodorant, a fire retardant, an anionic material, an infrared material, a CO conversion material, an aldehyde absorbent, and an oxygen enhancer.

11. A gas filter assembly, comprising a composite filter as claimed in claim 1 pleated in a zigzag fashion, and a frame for holding and surrounding said composite filter.
